(19) United States
(12) Patent Application Publication
(10) Pub. No.: US 2012/0235924 A1
(43) Pub. Date: Sep. 20, 2012

(54) DISPLAY SYSTEMS, METHODS, AND APPARATUS

(76) Inventors: Roland M. Hochmuth, Fort Collins, CO (US); Bradley L. Saunders, Fort Collins, CO (US); Donald Gonzalez, Redwood City, CA (US)

(21) Appl. No.: 13/049,337

(22) Filed: Mar. 16, 2011

(51) Int. Cl. G06F 3/041

(52) U.S. Cl. 345/173; 345/1.1

(57) ABSTRACT

In one implementation, a display system includes a first display client module, a second display client module, and a display control module. The display control module provides a first data set associated with a first region of a virtual display to the first display client module. The display control module also provides a second data set associated with a second region different from the first region of the virtual display to the second display client module. The first display client module is configured to output the first data set and to provide a first input event descriptor to the display control module at a first time. The second display client module is configured to output the second data set and to provide a second input event descriptor to the display control module at a second time.

### BACKGROUND

Multi-monitor display systems are used to display information graphically (or graphical information) at multiple monitors (or display devices). Such multi-monitor display systems are also referred to as video display walls, display walls, or video walls.

Typically, multi-monitor display systems use expensive and/or high-power graphics interface modules (e.g., graphics or video cards) installed at a computing device to display graphical information at multiple monitors. Such multi-monitor systems can be, however, extensive and require significant amounts of electrical energy to operate. Moreover, the computing devices hosting such multi-monitor display systems include a limited number of connections via which the computing device can be operatively coupled to the graphics interface modules, thus limiting the number of display devices that can be included in a multi-monitor display system.

Other multi-monitor display systems are distributed across multiple computing devices. That is, the display system includes multiple computing devices. Each computing device is connected to one or more display devices and generates or renders the graphical information that will be output to the display devices connected to that computing device. Accordingly, each computing device of the multi-monitor display systems requires the processing power to render the graphical information, thus increasing the cost of the computing devices and, therefore, the multi-monitor display system.

### BRIEF DESCRIPTION OF THE DRAWINGS

FIG. 1 is a schematic block diagram of a display system, according to an implementation.

FIG. 2 is a schematic block diagram of the display system of FIG. 1 including illustrations of input events, according to an implementation.

FIG. 3 is a schematic block diagram of a computing device configured as a display control module, according to an implementation.

FIG. 4 is a schematic block diagram of a computing device configured as a display client module, according to an implementation.

FIG. 5 is a flowchart of a display control process, according to an implementation.

FIG. 6 is a flowchart of a display control process, according to another implementation.

FIG. 7 is a flowchart of a display control process, according to another implementation.

FIG. 8 is a flowchart of a display client process, according to an implementation.

FIG. 9 is a flowchart of a display client process, according to another implementation.

FIG. 10 is a flowchart of a display client process, according to another implementation.

FIG. 11 is a schematic block diagram of a system including a processor and storage media, according to an implementation.

### DETAILED DESCRIPTION

Multi-monitor display systems (also referred to herein as display systems) include multiple monitors (or display devices) at which graphical information is displayed. Typically, multi-monitor display systems are used to increase a display size of a computer system. For example, a multi-monitor display system can include twelve display devices in a 3×4 matrix (i.e., three display devices in height and four display devices in width) and graphical information (e.g., a graphical user interface (“GUI”), image, video, and/or other graphical information) is displayed across the matrix of display devices. That is, the graphical information is divided into twelve regions, each region associated with a display device, and each region of the graphical information is displayed (or output) to the associated display device. In some implementations, all the graphical information is displayed at each display device. In other words, the graphical information can span all the display devices in the matrix or can be mirrored at each display device in the matrix.

Typically, multi-monitor display systems rely on sophisticated graphics interface modules (e.g., graphics or video cards) of a computing device. That is, one or more graphics interface modules that can output to the display devices are installed at a computing device and that computing device provides the graphical information to the display devices via the graphics interface modules. That is, the computing device hosts the multi-monitor display system. As a specific example, six graphics interface modules, each of which can output to two different display devices, can be installed at a computing device and drive (i.e., provide signals representing the regions of the graphical information to) the display devices of the multi-monitor display system. Such graphics interface modules can be expensive and require significant amounts of electrical energy to operate. Additionally, a computing device can include a limited number of connections via which the computing device can be operatively coupled to the graphics interface modules. Thus, the number of display devices that can be included in a multi-monitor display system can be limited.

Alternatively, some multi-monitor display systems are distributed across display devices at multiple computing devices. That is, such a multi-monitor display system includes multiple computing devices, each operatively coupled to one or more display devices. Typically, each computing device of such multi-monitor display systems generates or renders and then crops the graphical information before displaying the region of the graphical information associated with (or corresponding to) the display device (or display devices) operatively coupled to that computing device. Thus, for example, to display a video at the display devices of such a multi-monitor display system, a copy of the video is processed (e.g., read and rendered) at each computing devices within the multi-monitor display system.

Implementations discussed herein can output graphical information rendered at a display control module to multiple display devices each coupled to (or hosted at) multiple display client modules. For example, graphical information can be rendered or generated at one computing device (e.g., a display control module) and displayed across multiple display devices (i.e., spanning the multiple display devices), each of which is coupled to a different computing device (e.g., display client module). That is, the graphical information can be rendered at a display control module and displayed at multiple display client modules in communication one with another via, for example, a communications network. Thus, the display client modules need not render and/or crop (or modify) the graphical information that is provided by the display control module and is displayed at the display client modules. Accordingly, such display client modules can be based on (or implemented or hosted at) inexpensive and/or energy-efficient hardware platforms. For example, hardware platforms that include low-power processors and/or other low-power or energy-efficient components.

As used herein, the singular forms “a,” “an,” and “the” include plural referents unless the context clearly dictates otherwise. Thus, for example, the term “region” is intended to mean one or more regions or a combination of regions. Additionally, as used herein, the term “module” refers to hardware, circuitry such as circuitry implementing computing logic, and/or software, firmware, programming, machine- or processor-readable instructions, commands, or code that are stored at a memory and executed or interpreted (or hosted) at a processor.

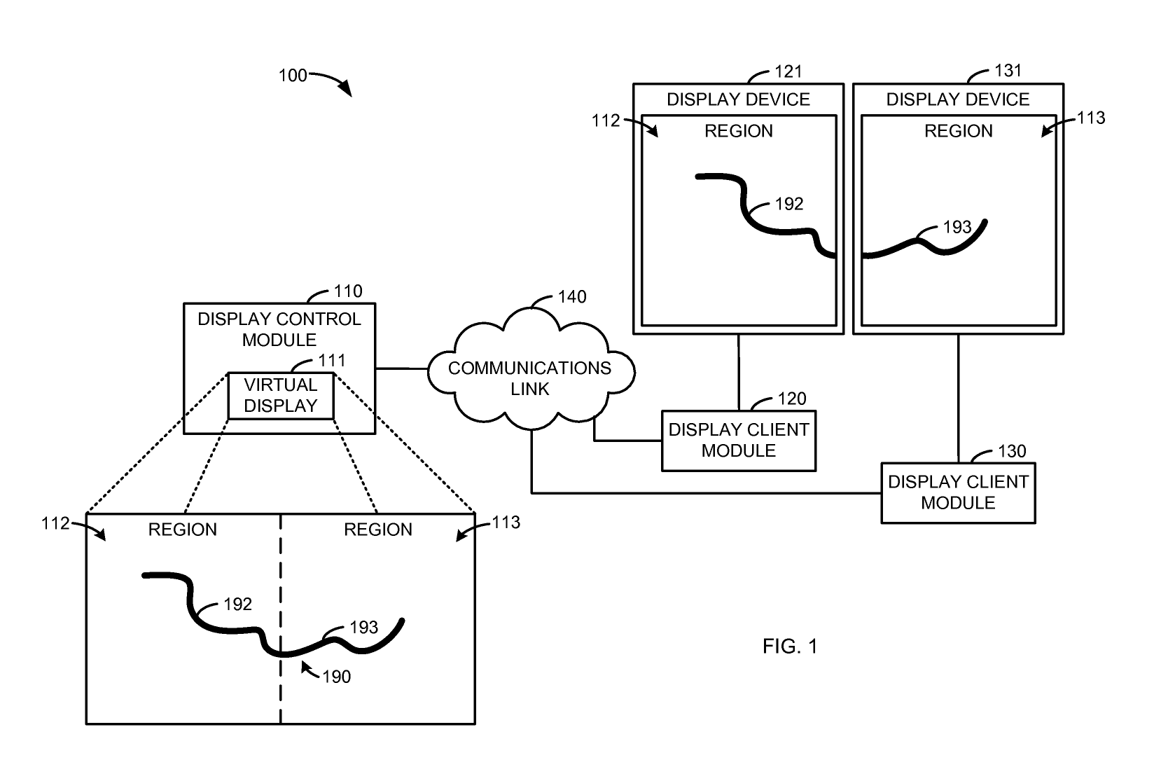

FIG. 1 is a schematic block diagram of a display system, according to an implementation. Display system 100 includes display control module 110, display client module 120, display client module 130, and communications link 140. Display client module 120 is operatively coupled to (e.g., via a display connection such as a Digital Visual Interface (“DVI”) connection, High-Definition Multimedia Interface (“HDMI”) connection, or Video Graphics Array (“VGA”)) display device 121. In other implementations, display client module 120 can include display device 121. That is, display device 121 can be integrated with display client module 120. Similarly, display client module 130 is operatively coupled to or includes display device 131.

Display system 100 is illustrated in FIG. 1 logically rather than physically. In other words, the placement of and connections among the resources of display system 100 (e.g., display control module 110, display client module 120, display client module 130, and communications link 140) represent logical relationships between the resources rather than their physical configuration. For example, display control module 110 and display client module 120 can be located at one physical location (i.e., at one computing device) and display client module 130 can be located at another physical location (i.e., at a different computing device). Said differently, the placement of and connections among the resources of display system 100 illustrate communication of data symbols or data signals transmitted within display system 100.

Display control module 110 generates images at virtual display 111, which includes regions (or portions) 112 and 113, and distributes data sets representing the portions of those images to display client modules 112 and 113. That is, display control module 110 draws, writes, or outputs graphical information at virtual display 111, and data sets representing that graphical information (i.e., graphical representations of information output to virtual display 111) at regions 112 and 113 are provided to display client modules 120 and 130 via communications link 140. Said differently, region 112 is associated with display client module 120 and region 113 is associated with display client module 130. The graphical information that is output to region 112 of virtual display 111 is provided via communications link 140 to display client module 120 and the graphical information that is output to region 113 of virtual display 111 is provided via communications link 140 to display client module 130. Display client modules 120 and 130 receive the graphical information provided by display control module 110 and display that graphical information at display devices 121 and 131, respectively.

In other implementations, display client modules 120 and 130 receive a data set that represents virtual display 111 and parse out or access data sets representing regions 112 and 113, respectively, from the data set representing virtual display 111. For example, a data set representing virtual display 111 can be an Extensible Markup Language (“XML”) document with elements including the data sets representing each of regions 112 and 113. Alternatively, the data set representing virtual display 111 can be an array or matrix and display client modules 120 and 130 can access the data sets representing regions 112 and 113 at known offsets or indices of that data set.

Moreover, although display client module 120 and display client module 130 are each illustrated in FIG. 1 operatively coupled to one display device—display devices 121 and 131, respectively—display client module 120 and display client module 130 can be in communication with multiple display modules. That is, display client module 120 and/or display client module 130 can be operatively coupled to multiple display devices. Furthermore, display system 100 can include more display client modules. Thus, virtual display 111 can include additional regions that are associated with additional display devices at display client module 120 and 130 and/or at additional display client modules.

Regions 112 and 113 are portions of virtual display 111. For example, region 112 and 113 can be different portions of virtual display 111. In some implementations region 112 is different from (i.e., not identical to) region 113, but includes some of region 113. That is, regions 112 and 113 can overlap. In some implementations, region 112 is unique from region 113. That is, region 112 does not overlap with region 113.

As a specific example of a display system, display control module 110, display client module 120, and display client module 130 can be computing devices in communication one with another via communications link 140. Display control module 110 does not include a display device (e.g., a monitor, screen, or other graphical output device). Rather, display control module 110 outputs graphical information to virtual display 111. Virtual display 111 includes a memory buffer (e.g., a display buffer) to which display control module 110 can write graphical information (or draw). As a specific example, virtual display 111 can be a virtual device driver hosted at display control module 110, to which an operating system of display control module 110 can output graphical information similar to outputting graphical information to a display device.

After display control module 110 draws to virtual display 111, display control module 110 provides data sets representing the graphical information at virtual display 111 to display client modules 120 and 130. As illustrated in FIG. 1, the graphical information within region 112 of virtual display 111 is provided to display client module 120. Display client module 120 outputs the graphical information within region 112 of virtual display 111 to display device 121. Similarly, the graphical information within region 113 of virtual display 111 is provided to display client module 130. Display client module 130 outputs the graphical information within region 113 of virtual display 111 to display device 131.

Thus, a user of display control module 110 views the graphical information drawn to virtual display 111 at display devices 121 and 131. For example, graphical element 190 drawn to virtual display 111 includes portion 192 at (or within) region 112 of virtual display 111 and portion 193 at region 113 of virtual display 111. Portion 192 of graphical element 190 is provided to display client module 120 and output at display device 121, and portion 193 of graphical element 190 is provided to display client module 130 and output at display device 131.

Additionally, display client modules 120 and 130 provide input event descriptors that represent input events to display control module 110. An input event is an event or action such as, for example, a depression or release of a button at a keyboard, mouse, game controller (e.g., a joystick), or touch-enabled or proximity-sensing input device such as trackpad or display device; a movement at a mouse, trackpad, or game controller; a multi-touch input event (e.g., an input event resulting from complex inputs such as multiple contacts, multiple movements, or prolonged contact) such as a gesture at a trackpad, mouse, or touch-enabled or proximity-sensing input device such as a trackpad or display device.

An input event descriptor is a data set that describes (or defines or represents) an input event. In some implementations, an input event such as a multi-touch input event includes multiple input events and/or is described or defined by multiple input event descriptors. That is, a multi-touch input event can include multiple input events, each described by an input event descriptor, that are aggregated or collected at an input processing engine to define the resulting multi-touch input event and/or multi-touch input event descriptor.

As an example, a mouse (not shown) can be operatively coupled to display client module 120 and a trackpad (not shown) can be operatively coupled to display client module 130. Movement of the mouse results in generation of input events and, subsequently, of input event descriptors that describe those movements at display client module 120. These input events are relative to display device 121. For example, an input event descriptor representing one of these input events can specify a Cartesian coordinate location (e.g., a number of pixels or a logical display unit) of the end of a movement of the mouse in reference to a reference location (e.g., [0,0] location) at the upper left corner of display device 121.

Similarly, contact with the trackpad results in generation of input events and, subsequently, of input event descriptors that describe that contact at display client module 130. These input events are relative to display device 131. For example, an input event descriptor representing one of these input events can specify a Cartesian coordinate location (e.g., a number of pixels or a logical display unit) of a contact with the trackpad in reference to a reference location (e.g., [0,0] location) at the lower right corner of display device 131.

The input event descriptors are provided from display client modules 120 and 130 to display control module 110. Display control module 110 receives the input event descriptors and modifies the input event descriptors (or generates new input event descriptors) to be relative to virtual display 111. That is, display control module 110 can alter (e.g., change by an offset) the Cartesian coordinate locations that are included at the input event descriptors and are relative to display client module 120 or display client module 130, depending on the source of each input event descriptor. For example, display control module 110 can access a position identifier of region 112 and a position identifier of region 113 and modify the input event descriptors to be relative to virtual display 111 based on offsets or mappings (e.g., offset or mapping values and/or functions) included at those position identifiers. The position identifiers provide an offset or mapping of region 112 and region 113 relative to a reference location of virtual display 111. In some implementations, position identifiers also provide an offset or mapping of the reference locations of display client modules 120 and 130 (or, of display devices 121 and 131) to a reference location of virtual display 111.

With reference to the reference locations of display devices 121 and 131 discussed above, a position identifier for (or associated with) display client module 120 can specify an offset of zero from the upper left corner of virtual display 111 for region 112, and a one-to-one mapping of the reference location (e.g., upper left corner) of display device 121 to the reference location (e.g., upper left corner) of virtual display 111. Similarly, a position identifier for display client module 130 can specify an offset of the width of region 112 from the upper left corner of virtual display 111 for region 113, and a mapping that relates the reference location (e.g., lower right corner) of display device 131 to the reference location (e.g., upper left corner) of virtual display 111. Thus, an input event that occurred at the center of display device 121 appears (i.e., is interpreted by the input processing engine of display control module 110) to have occurred at display control module at the center of region 112. Similarly, an input event that occurred at the upper left corner of display device 131 appears to have occurred at display control module 110 at the upper left corner of region 113 (i.e., at the top center of virtual display 111).

After display control module 110 has modified the input event descriptors to be relative to virtual display 111, the input event descriptors are provided to an input processing engine (not shown) of display control module. The input processing engine can be, for example, a component of an operating system such as a virtual device driver that interprets input events for the operating system.

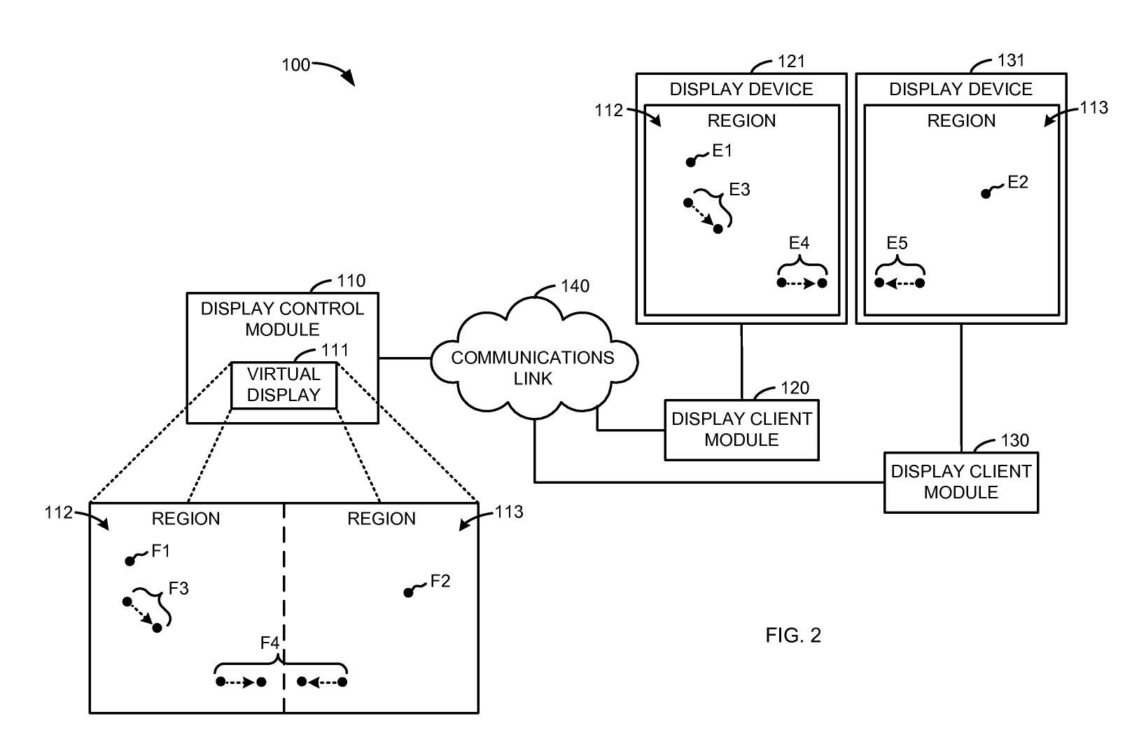

As specific examples of input events within display system 100, FIG. 2 is a schematic block diagram of the display system of FIG. 1 including illustrations of input events, according to an implementation. E1, E2, E3, E4, and E5 illustrate input events at display devices 121 and 131. As an example, display devices 121 and 131 can be touch-sensitive display devices (e.g., resistive, capacitive, or other touch screens) and E1, E2, E3, E4, and E5 represent input events (e.g., contact by a user with a stylus or finger) with display devices 121 and 131. When the user contacts (e.g., touches) display device 121 at E1, an input event descriptor representing an input event is generated relative to display device 121 at display client module 120, and is provided to display control module 110 via communications link 140. Display control module 110 receives that input event descriptor, modifies that input event descriptor (or generates a new input event descriptor based on that input event descriptor) relative to virtual display 111 (e.g., using a position indicator for display client module 120), and provides that input event descriptor to an input processing engine of display control module 110. Because that input event descriptor is relative to virtual display 111 when it is provided to the input processing engine, E1 (i.e., the input event originating from display device 121) appears to the input processing engine to have originated at F1 at virtual display 111. Similarly, an input event descriptor is generated at display client module 130 and provided to display control module 110 in response to the input event at E2. That input event descriptor is modified at display control module 110 to be relative to virtual display 111 and provided to an input processing engine of display control module 110. Thus, that input event descriptor appears to the input processing engine to have occurred or been detected at F2 at virtual display 111.

E3 also represents an input event at display device 121. More specifically, E3 represents a movement input event at display device 121. For example, a user makes contact with display device 121 using a finger, moves the finger along the dotted line in the direction of the arrow, and breaks contact with display device 121. An input event descriptor is generated at display client module 120 and provided to display control module 110. In some implementations, a group of input event descriptors are generated at display client module 120 in response to the input event represented by E3, and each of these input event descriptors are provided to display control module 110. For example, an input event descriptor indicating the location or position in Cartesian coordinates relative to a reference location of display device 121 can be generated every 50 milliseconds (or at some other period or frequency) while the user is in contact with display device 121.

Similarly to E1 and E2, the input event descriptor (or group of input event descriptors) describing the input event at E3 is modified at display control module 110 to be relative to virtual display 111. The modified input event descriptor (or group of modified input event descriptors) is then provided to an input processing engine with which display control module 110 is in communication. Because the modified input event descriptor (or group of modified input event descriptors) is relative to virtual display 111, the input processing engine interprets the modified input event descriptor (or group of modified input event descriptors) as describing an input event at F3.

E4 and E5 represent input events at display devices 121 and 131, respectively. These input events define a multi-touch input event (e.g., two fingers making contact with a display device and being moved together) distributed across display device 121 and 131. That is, the multi-touch input event (or gesture) does not occur (i.e., is not detected or made) at a single display device, rather part of the gesture (i.e., the input event at E4) occurs at display device 121 and another part of the gesture (i.e., the input event at E5) occurs at display device 131. Display client module 120 generates an input event descriptor (or group of input event descriptors as discussed above in relation to E3) describing the input event at E4, and provides that input event descriptor to display control module 110. Display client module 130 generates an input event descriptor (or group of input event descriptors as discussed above in relation to E3) describing the input event at E5 and provides that input event descriptor to display control module 110.

Display control module 110 receives the input event descriptor describing the input event at E4 and the input event descriptor describing the input event at E5. In some implementations, display control module 110 modifies these input event descriptors to be relative to virtual display 111 as discussed above and provides the modified (or new) input event descriptors to an input processing engine. In such implementations, the input processing engine determines that the input events described by these input event descriptors represent a gesture relative to virtual display 111 at F4. In other words, display control module 110 provides the input event descriptors to the input processing engine as though the input event descriptors were detected relative to virtual display 111 (e.g., as though virtual display 111 is a touch-sensitive display device and the input events at E4 and E5 were at virtual display 111), and the input processing engine includes logic and/or processing modules to determine what input events (e.g., multi-touch input events, contact input events, or movement input events) the input event descriptors represent or describe. Here, the input processing engine can determine that the input event descriptor or input event descriptors representing input events at E4 and E5 describe (or should be interpreted as) a gesture at F4 at virtual display 111.

In some implementations, display control module 110 processes or analyzes these input event descriptors to determine what input events (e.g., multi-touch input events, gestures, contact input events, or movement input events) the input event descriptors represent or describe and provide multi-touch input event descriptors to an input processing engine. For example, display control module 110 can temporarily store (or cache or buffer) input event descriptors for intervals of time (e.g., 1 second) after an initial input event descriptor is received (i.e., relative to that initial input event descriptor) or at absolute intervals. If additional input event descriptors are received during an interval, display control module 110 can analyze these input event descriptors to determine whether two or more input event descriptors satisfy a pattern for a gesture or other multi-touch input event, aggregate those input event descriptors into one or more multi-touch input event descriptors, and provide the one or more multi-touch input event descriptors to an input processing engine. That is, display control module 110 can interpret or process input events (e.g., multi-touch input events) before providing input event descriptors describing those input events to an input processing engine.

Communications link 140 can include any connector and/or system that allows display control module 110, display client module 120, display client module 130, and communications link 140 to communicate with one another. For example, communications link 140 can be one or more of a cable (e.g., telecommunication cable, twisted-pair cable, coaxial cable, or fiber-optic cable), wireless link or connection (e.g., radio-frequency link, wireless optical link, or infrared link), or any other connector or system that supports transmission of communications symbols. Additionally, communications link 140 can include a communications network or combination of communications networks capable of transmitting information (e.g., symbols or signals representing data) such as, for example, an Ethernet network, a fiber-optic network, a wireless network, an intranet, an Internet Protocol network, a packet-switching network, and/or the Internet.

In some implementations, communications link 140 can include multiple communications links and/or communications networks operatively coupled one to another by, for example, bridges, routers, switches, hubs, and/or gateways. For example, display client module 130 can be operatively coupled to a cellular network (not shown) and display control module 110 can be operatively coupled to a fiber-optic network (not shown). The cellular network and fiber-optic network can each be operatively coupled one to another via one or more network bridges, routers, switches, and/or gateways such that the cellular network and the fiber-optic network are operatively coupled to form a communications link. Alternatively, the cellular network and fiber-optic network can each be operatively coupled one to another via one or more additional communications networks. For example, the cellular network and the fiber-optic network can each be operatively coupled to the Internet such that the cellular network, the fiber-optic network and the Internet are operatively coupled to form a communications link.

Data sets representing input event descriptors, virtual display 111 (i.e., data sets representing graphical information thereat), region 112 (i.e., data sets representing graphical information thereat), and/or region 113(i.e., data sets representing graphical information thereat) can be provided via communications link 140 to display control module 110, display client module 120, and/or display client module 130 using various methodologies. For example, data sets can be provided by sending the data sets using unicast addressing, multicast addressing, or broadcast addressing to display control module 110, display client module 120, and/or display client module 130. Alternatively, for example, data sets can be provided by storing the data set at a location (e.g., a data store or data storage service referenced by a Uniform Resource Identifier (“URI”)) such as an electronic mailbox at which display control module 111, display client module 120, and/or display client module 130 can access the data sets. The storing and/or accessing can be via communications link 140. This location can be known to the recipient or recipients (e.g., display control module 110, display client module 120, and/or display client module 130) a priori or can be separately provided to the recipient or recipients. Furthermore, in some implementations, a signal can be sent via communications link 140 to display control module 110, display client module 120, and/or display client module 130 to indicate that a data set can be accessed at the location.

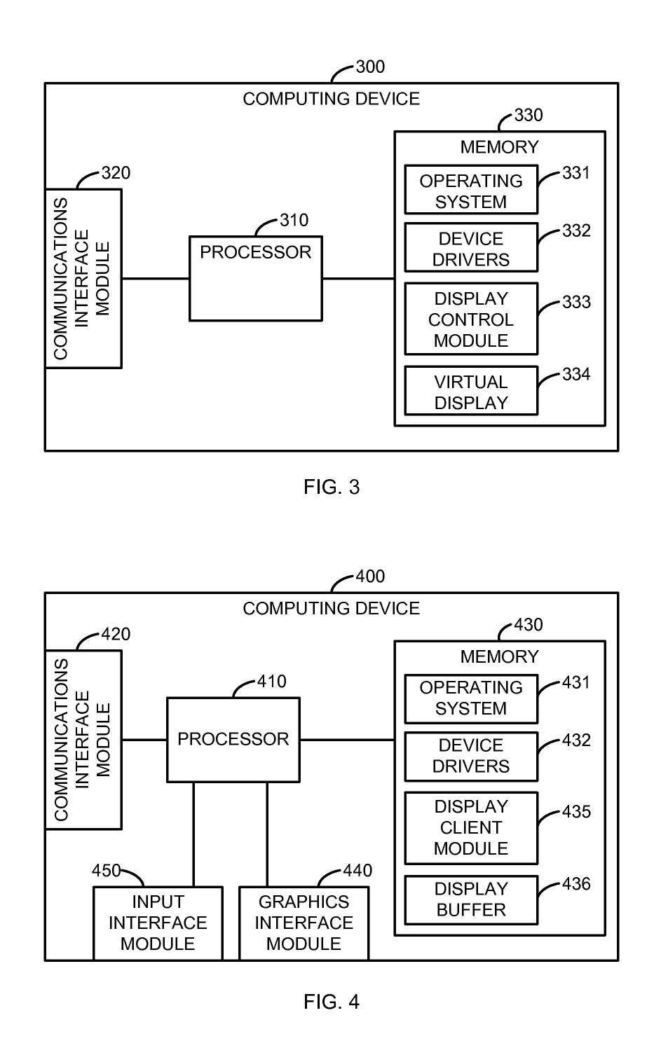

FIG. 3 is a schematic block diagram of a computing device configured as a display control module, according to an implementation. Computing device 300 includes communications interface module 320, processor 310, and memory 330. Processor 310 is operatively coupled to communications interface module 320 and memory 330. Processor 310 is any of a variety of processors. For example, processor 310 can be a general-purpose processor or an application-specific processor implemented as a hardware module and/or a software module hosted at a hardware module. A hardware module can be, for example, a microprocessor, a microcontroller, an application-specific integrated circuit (“ASIC”), a programmable logic device (“PLD”) such as a field programmable gate array (“FPGA”), and/or other electronic circuits that perform operations. A software module can be, for example, instructions, commands, and/or codes stored at a memory and executed at another processor. Such a software module can be defined using one or more programming languages such as Java™, C++, C, an assembly language, a hardware description language, and/or another suitable programming language. For example, a processor can be a virtual machine hosted at a computer server including a microprocessor and a memory.

In some implementations, processor 310 can include multiple processors. For example, processor 310 can be a microprocessor including multiple processing engines (e.g., computation, algorithmic or thread cores). As another example, processor 310 can be a computing device including multiple processors with a shared clock, memory bus, input/output bus, and/or other shared resources. Furthermore, processor 310 can be a distributed processor. For example, processor 310 can include multiple computing devices, each including a processor, in communication one with another via a communications link such as a computer network.

Typically, as illustrated in FIG. 3, memory 330 includes instructions or codes (e.g., computer codes or object codes) defining software modules that are executed by (or hosted at) processor 310 during operation of computing device 310. For example, memory 330 includes instructions that define operating system 331, device drivers 332, display control module 333, and virtual display 334. Additionally, although not illustrated in FIG. 3, memory 330 can include other software modules such as applications (e.g., software application programs). In other words, operating system 331, device drivers 332, display control module 333, virtual display 334, and other software modules stored as instructions (not shown) at memory 330 and executed at processor 310 are hosted at computing device 300. Computing device 300 can be referred to as a display control module because computing device 300 hosts display control module 333 (e.g., a software application).

In some implementations, computing device 300 also includes a non-volatile (or non-transient) processor-readable medium (not shown) having instructions or computer code thereon that are accessed by processor 310 to perform various processor-implemented operations. For example, processor 310 (or another module such as a direct memory addressing module) can copy such instructions from the non-volatile processor-readable medium to memory 330, and processor 310 can execute those instructions from memory 330.

Examples of processor-readable media include, but are not limited to: magnetic storage media such as a hard disk, a floppy disk, and/or magnetic tape; optical storage media such as a compact disc (“CD”), a digital video disc (“DVDs”), a compact disc read-only memory (“CD-ROM”), and/or a holographic device; magneto-optical storage media; non-volatile memory such as read-only memory (“ROM”), programmable read-only memory (“PROM”), erasable programmable read-only memory (“EPROM”), electronically erasable read-only memory (“EEPROM”), and/or FLASH memory; and random-access memory (“RAM”). Examples of computer code include, but are not limited to, micro-code or micro-instructions, machine instructions, such as produced by a compiler, and files containing higher-level instructions that are executed by a computer using an interpreter. For example, an implementation may be implemented using Java™, C++, or other object-oriented programming language and development tools. Additional examples of computer code include, but are not limited to, control signals, encrypted code, and compressed code.

Communications interface module 320 is an interface accessible to processor 310 to communicate with (i.e., transmit symbols representing data to and receive such symbols from) other processors and/or computing devices via a communications link. In other words, communications interface module 320 can receive data from processor 310 and transmit symbols representing those data via a communications link. For example, processor 310 can provide regions of images or other graphical information at virtual display 334 to display client modules via communications interface module 320 based on codes or instructions stored at display control module 333 and executed at processor 310. Moreover, communications interface module 320 can receive symbols from other communications interfaces via a communications link and send data represented by those symbols to processor 310. For example, communications interface module 320 can be a telephone network interface, a twisted-pair network interface, a coaxial network interface, a fiber-optic network interface, a wireless network interface such as a wireless local area network (“WLAN”) or a cellular network, and/or some other network or communications interface. As a specific example, processor 310 can receive input event descriptors via communications interface module 320 and provide those input event descriptors to display control module 333 when display control module 333 is hosted at processor 310.

FIG. 4 is a schematic block diagram of a computing device configured as a display client module, according to an implementation. As illustrated in FIG. 4, computing device 400 includes communications interface module 420, processor 410, memory 430, graphics interface module 440, and input interface module 450. Processor 410 is operatively coupled to communications interface module 420 and memory 430. Communications interface module 420 and memory 430 are similar to communications interface 320 and memory 330, respectively, discussed above in reference to FIG. 3. Memory 430 includes instructions that define operating system 431, device drivers 432, display client module 435, and display buffer 436. In other words, operating system 431, device drivers 432, display control module 435, virtual display 436, and other software modules stored as instructions (not shown) at memory 430 and executed at processor 410 are hosted at computing device 400.

Graphics interface module 440 provides signals representing images or other graphical information to a display device operatively coupled to computing device 400 via graphics interface module 440. That is, for example, display client module 435 can output graphical information to a display device via graphics interface module 440. As a specific example, display client module 435 can receive a data set representing a region of a virtual display from a display client module and draw that data set (e.g., a copy of the region of the virtual display) to display buffer 436. Graphics interface module 440 can then access display buffer 436 and output signals representing the graphical information at display buffer 436 to a display device. In other words, a copy of the region of the virtual display can be displayed at the display device.

In some implementations, computing device 400 can be operatively coupled to multiple display devices via graphics interface module 440 and/or via additional graphics interface modules (not shown), and can output graphical information to each of the multiple display devices. That is, multiple display devices can be coupled to computing device 400 at graphics interface module 440 and/or at other graphics interface modules (not shown), and a region of a virtual display output to each display device. In other words, multiple regions (e.g., one per display device) of the virtual display can be associated with display client module 435 hosted at computing device 400, and each region is output to a display device operatively coupled to graphics interface module 440 and/or at other graphics interface modules (not shown).

Input interface module 450 receives input (e.g., input events) from one or more input devices operatively coupled to computing device 400 via input interface module 450. That is, input interface module 450 receives signals representing input events from input devices such as a mouse, a keyboard, a trackpad, a touch-sensitive or proximity-detecting matrix or input component of a display device, game controller, or other input device. These signals (or other signals based on these signals) are provided to display client module 435 when display client module 435 is hosted at processor 410. For example, input interface module can be a Universal Serial Port (“USB”) module (e.g., transceiver and software stack hosted at a processor), a serial (e.g., PS/2) module, and/or other input interface module. Display client module 435 can then generate input event descriptors based on these signals and send the input event descriptors to a display control module via communications interface module 420.

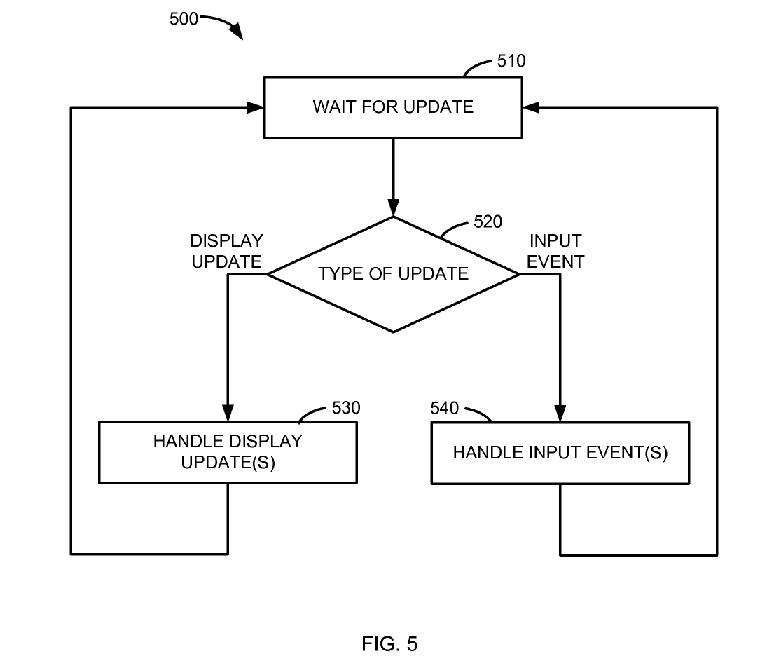

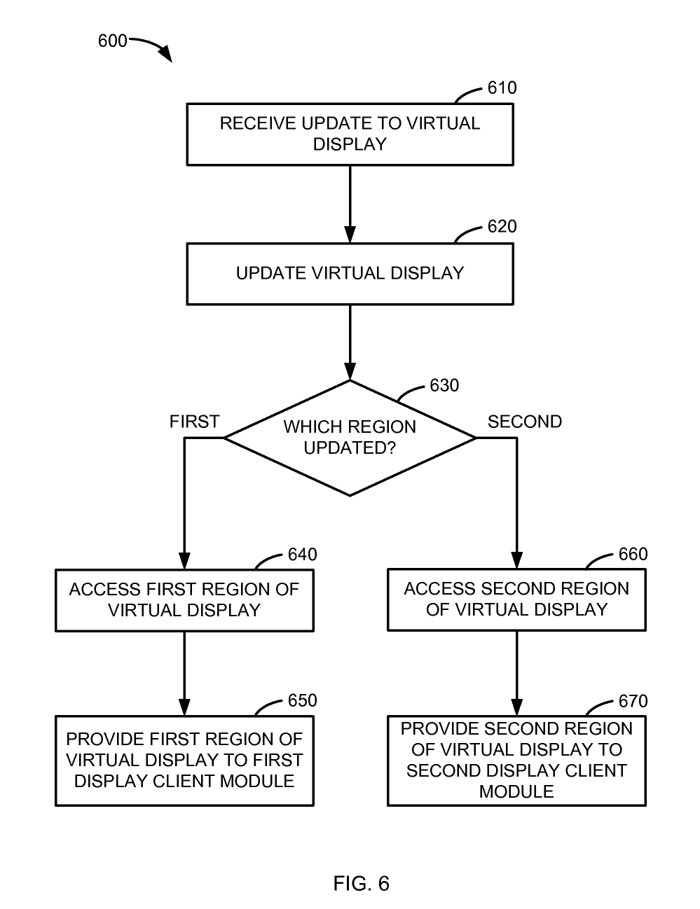

FIG. 5 is a flowchart of a display control process, according to an implementation. Process 500 can be implemented as a hardware module, as a software module hosted at a computing device, and/or as a combination of a hardware module and a software module. For example, process 500 can be implemented as application-specific circuitry or as a software module including instructions stored at a memory and executed at a processor in communication with the memory. More specifically, for example, process 500 can be implemented at a display control module within a display system.

Process 500 waits at block 510 for updates to a virtual display or input event descriptors. When an update is received (e.g., an input event descriptor is received from a display client module or graphical information is drawn to or received for a virtual display), process 500 determines the type of update at block 520. If the update is an update to a virtual display (e.g., an operating system or software module hosted at a processor has drawn to or requested to draw to or access the virtual display), process 500 proceeds to block 530 at which the update or updates to the virtual display are handled (or processed). FIG. 6, discussed in more detail below, is an example of a process to handle updates to a virtual display. After the update or updates to the virtual display are handled at block 530, process 500 proceeds to block 510 and waits for additional updates.

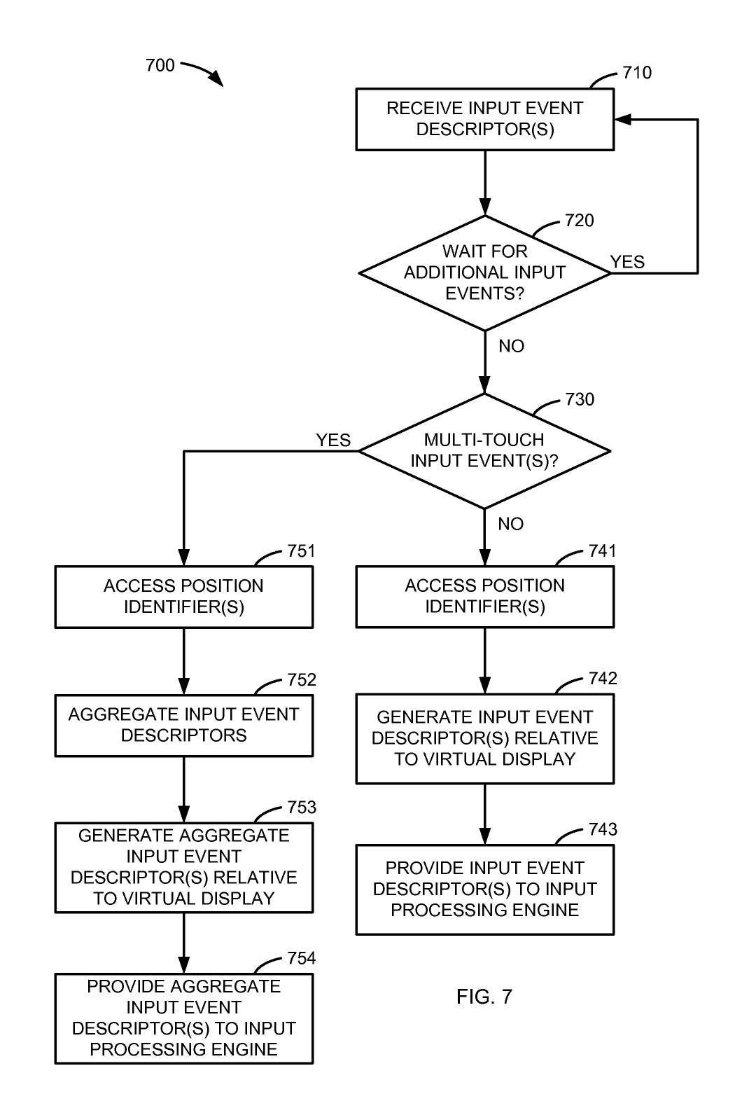

If, at block 520, the update is an input event (e.g., an input event descriptor representing an input event is received at a display control module), process 500 proceeds to block 540 at which the input event or input events are handled (or processed). FIG. 7, discussed in more detail below, is an example of a process to handle input events. After the input event or input events are handled at block 540, process 500 proceeds to block 510 and waits for additional updates.

Process 500 can include additional or fewer blocks than those illustrated in FIG. 5. Additionally, one or more blocks can be rearranged or discarded. Furthermore, although process 500 is discussed above with reference to an example environment within a display system, process 500 is applicable within other environments.

FIG. 6 is a flowchart of a display control process, according to another implementation. Process 600 can be implemented as a hardware module, as a software module hosted at a computing device, and/or as a combination of a hardware module and a software module. For example, process 600 can be implemented as application-specific circuitry or as a software module including instructions stored at a memory and executed at a processor in communication with the memory. More specifically, for example, process 600 can be implemented at a display control module within a display system to handle updates to a virtual display at the display control module.

An update to the virtual display is received at block 610. An update to a virtual display can be, for example, a signal indicating that a virtual display has been updated or instructions or codes describing what or how graphical information should be drawn to the virtual display. The virtual display is updated at block 620, for example, based on instructions or codes that specify how the virtual display should be updated. In some implementations, the update received at block 610 is an indication or signal that the virtual display has been updated and block 620 is not performed. Process 600 (or a display control module implementing process 600) then determines which region or regions of the virtual display were updated at block 630.

If the first region of the virtual display was updated (e.g., graphical information at that region of the virtual display was altered), process 600 proceeds to block 640, at which the first region of the virtual device is accessed. For example, the graphical information (e.g., data values representing pixel values) at the first region can be read at block 640 and included in a data set representing the first region (i.e., the graphical information at the first region). The first region of the virtual display (i.e., a data set representing the first region) is provided to a first display client module at block 650. The first display client module can be associated with the first region. That is, the first display client module is designated to receive and/or display the first region at a display device operatively coupled to the first display client module. In some implementations, the first region is uniquely provided to the first display client module. That is the first region is provided to the first display client module and not to other display client modules.

Similarly, if the second region of the virtual display was updated or if both the first region and the second region of the virtual display were updated, process 600 proceeds from block 630 (or from block 650 if the first region and the second region were updated and the display control module is unable to concurrently execute multiple blocks) to block 660, at which the second region of the virtual device is accessed. For example, the graphical information (e.g., data values representing pixel values) at the second region can be read at block 660 and included in a data set representing the second region (i.e., the graphical information at the second region). The second region of the virtual display (i.e., a data set representing the second region) is provided to a second display client module at block 670. The second display client module can be associated with the second region. That is, the second display client module is designated to receive and/or display the second region at a display device operatively coupled to the second display client module. In some implementations, the second region is uniquely provided to the second display client module. That is the second region is provided to the second display client module and not to other display client modules.

Process 600 can include additional or fewer blocks than those illustrated in FIG. 6. For example, a virtual display can include more than two regions, and process 600 can include blocks analogous to blocks 640 and 650 for each region of the virtual display. As another example, the data sets representing the first region and the second region can be compressed, encrypted, and/or otherwise encoded before being provided to the first display client module and the second display client module, respectively. That is, process 600 can include encoding (e.g., compression or encryption) blocks after blocks 640 and 660 and before blocks 650 and 670, respectively. Additionally, one or more blocks can be rearranged or discarded. For example, a data set representing both the first region and the second region can be provided to each of the first display client module and the second display client module if either the first region or the second region was updated. The first display client module and the second display client module can then access the data set for the appropriate region (i.e., first region or second region, respectively) from the data set of both regions, and each can update a display device based on the data set for the appropriate region. Furthermore, although process 600 is discussed above with reference to an example environment within a display system, process 600 is applicable within other environments.

FIG. 7 is a flowchart of a display control process, according to another implementation. Process 700 can be implemented as a hardware module, as a software module hosted at a computing device, and/or as a combination of a hardware module and a software module. For example, process 700 can be implemented as application-specific circuitry or as a software module including instructions stored at a memory and executed at a processor in communication with the memory. More specifically, for example, process 700 can be implemented at a display control module within a display system.

Input event descriptors are received at block 710 from, for example, one or more display client modules. Typically, each input event descriptor is uniquely received from a display client module. That is, an input event descriptor is received from a display client module at which that input event descriptor is generated or defined, and is not received from other display client modules.

If process 700 is configured (e.g., if a display control module implementing process 700 is configured) at block 720 to wait for additional input event descriptors, for example, to analyze or process input event descriptors to identify or recognize multi-touch input events, process 700 proceeds to block 710 to receive additional input event descriptors and/or until a timeout value (e.g., a time interval) expires. In process 700 should not wait for additional input event descriptors at block 720 (e.g., process 700 is not configured to wait for additional input event descriptors, a sufficient number of input event descriptors have been received, and/or a time interval has expired), process 700 proceeds to block 730 to determine whether the input event descriptor or input event descriptors represent or describe a multi-touch input event.

If the input event descriptors do not describe a multi-touch input event, process 700 proceeds to block 741 and accesses position identifiers related to the input event descriptors (e.g., position identifiers associated with the display client modules from which the input event descriptors were received at block 710). For example, the position identifier can be accessed at a database or lookup table based on a source or origination identifier included in the input event descriptors or received with the input event descriptors. For example, an input event descriptor can include an identifier of a display client module within a display system. As another example, an Internet Protocol (“IP”) address associated with the display client module that provided the input event descriptor can be received in a data packet including the input event descriptor.

The position identifiers are used to generate, at block 742, input event descriptors that are relative to a virtual display of a display control module implementing process 700 from the received input event descriptors that are relative to the display client modules (or display devices at those display client module). That is, the offset values, mapping values or functions (i.e., a mathematical operation that maps a location relative to a display client module to a location relative to the virtual display), and/or other values or functions of the position identifiers are applied to the input event descriptors to modify the input event descriptors to be relative to the virtual display or to generate new input event descriptors from the input event descriptors received at block 710.

The input event descriptors that are relative to the virtual display are then provided to an input processing engine at block 743. For example, the input event descriptors can be provided to an input event queue of an operating system hosted at or in communication with a display control module. The operating system can then provide processed input event signals or messages based on those input event descriptors to software applications.

If the input event descriptors do describe a multi-touch input event at block 730, process 700 proceeds to block 751 at which position identifiers related to the input event descriptors (e.g., position identifiers associated with the display client modules from which the input event descriptors were received at block 710) are accessed. The input event descriptors are then aggregated at block 752 into one or more aggregate input event descriptors that represent a multi-touch input event (i.e., a multi-touch input event descriptor). That is the input event descriptors are combined at block 752 to define one or more aggregate input event descriptors that represent a multi-touch input event. For example, an aggregate (or multi-touch) input event descriptor can describe a gesture such as a circular input event (e.g., contact with a touch-sensitive input device and circular movement relative to that input device) or multiple substantially simultaneous contact input events that occurred at different display devices and/or were originally represented by multiple input event descriptors.

The position identifiers accessed at block 751 are used at block 752 to determine and provide a common reference location for aggregation of the input event descriptors. That is, the position identifiers can be used to offset or map data values at input event descriptors from various display client modules that represent locations of input events relative to the various display client modules to a common reference location (or reference frame or context). For example, the data values within the input event descriptors that represent locations of input events can be offset or mapped to have a reference location of a particular display client module from the various display client modules. Alternatively, those data values can be offset or mapped to have a reference location of the virtual display of the display control module implementing process 700. That is, the data values can be modified to be relative to the virtual display at block 752 before or while being aggregated and the aggregate input event descriptor or aggregate input event descriptors are relative to the virtual display.

If the aggregate input event descriptor or aggregate input event descriptors were not modified to be relative to the virtual display at block 752, aggregate input event descriptors that are relative to the virtual display are generated at block 753. Similar to block 742, the aggregate input event descriptors relative to the virtual display can be generated based on the position identifiers accessed at block 751 and the aggregate input event descriptors from block 752. In other words, the aggregate input event descriptors relative to a reference location of one or more display client modules or to another reference location are offset or mapped to be relative to the virtual display using offset or mapping values or functions of the position identifiers. The aggregate input event descriptors that are relative to the virtual display are then provided to an input processing engine at block 754.

Process 700 can include additional or fewer blocks than those illustrated in FIG. 7. For example, in some implementations, process 700 does not handle or interpret input event descriptors to identify multi-touch input events. Thus, blocks 730, 751, 752, 753, and 754 can be excluded, and process 700 can collect input event descriptors for a time interval and/or until a particular (e.g., predetermined) number of input event descriptors are received, modify the input event descriptors to be relative to the virtual display, and provide those modified input event descriptors to the input processing engine. Alternatively, process 700 can modify and provide input event descriptors to the input processing engine as the input event descriptors are received without caching or buffering input event descriptors. Additionally, one or more blocks can be rearranged or discarded. Furthermore, although process 700 is discussed above with reference to an example environment within a display system, process 700 is applicable within other environments.

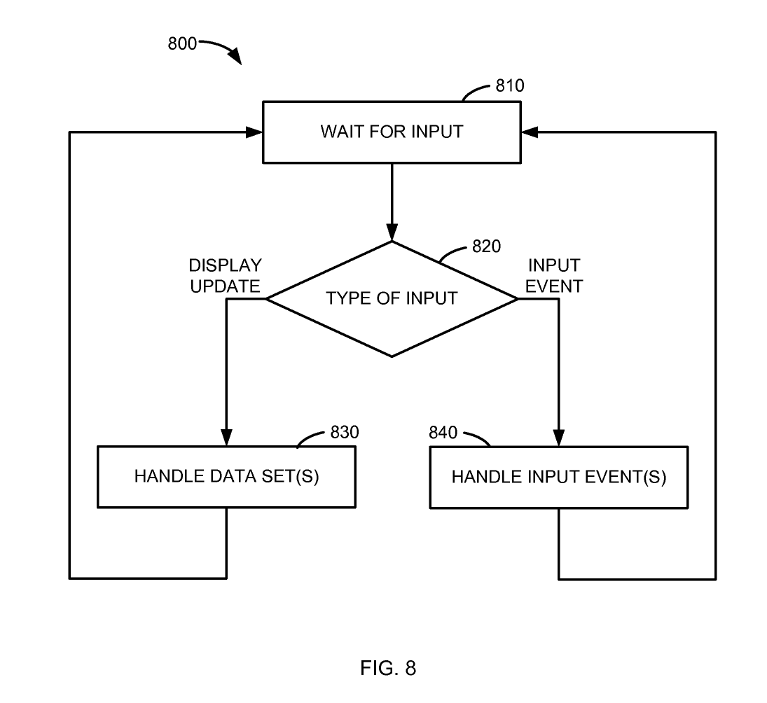

FIG. 8 is a flowchart of a display client process, according to an implementation. Process 800 can be implemented as a hardware module, as a software module hosted at a computing device, and/or as a combination of a hardware module and a software module. For example, process 800 can be implemented as application-specific circuitry or as a software module including instructions stored at a memory and executed at a processor in communication with the memory. More specifically, for example, process 800 can be implemented at a display client module within a display system.

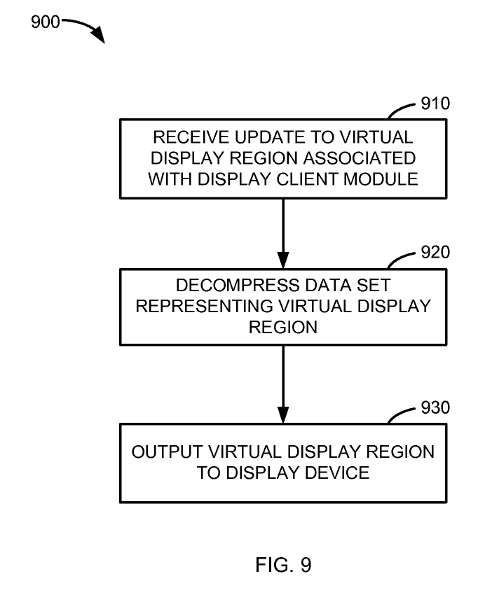

Process 800 waits at block 810 for input from a display control module or from an input device such as a mouse, a trackpad, a touch-sensitive or proximity-sensing input surface, gamepad, keyboard, and/or some other input device. When an input is received (e.g., an input event or data set representing graphical information at a region of a virtual display), process 800 determines the type of input at block 820. If the input is a data set representing a display update to a region of the virtual display (e.g., the region of the virtual display associated with the display client module implementing process 800 has been updated), process 800 proceeds to block 830 at which the data set or data sets are handled (or processed). FIG. 9, discussed in more detail below, is an example of a process to handle data sets representing regions of a virtual display. After the data set or data sets are handled at block 830, process 800 proceeds to block 810 and waits for additional input.

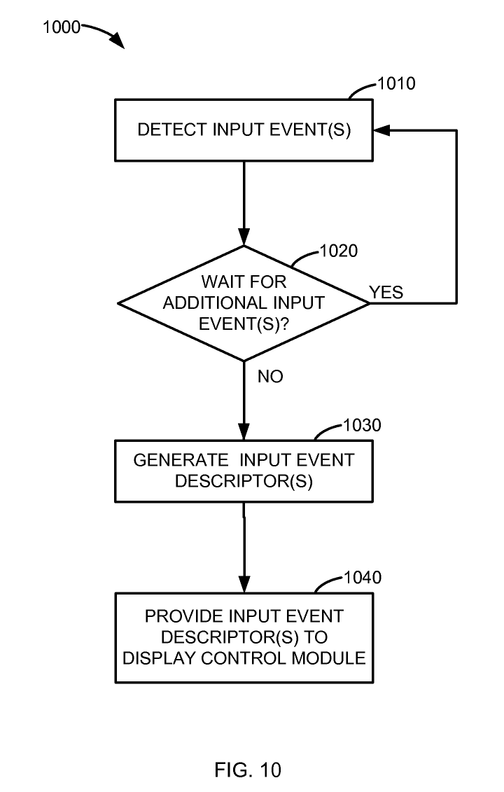

If, at block 820, the update is an input event (e.g., a signal at an input interface module of a display client module), process 800 proceeds to block 840 at which the input event or input events are handled (or processed). FIG. 10, discussed in more detail below, is an example of a process to handle input events. After the input event or input events are handled at block 840, process 800 proceeds to block 810 and waits for additional input.

Process 800 can include additional or fewer blocks than those illustrated in FIG. 8. Additionally, one or more blocks can be rearranged or discarded. Furthermore, although process 800 is discussed above with reference to an example environment within a display system, process 800 is applicable within other environments.

FIG. 9 is a flowchart of a display client process, according to another implementation. Process 900 can be implemented as a hardware module, as a software module hosted at a computing device, and/or as a combination of a hardware module and a software module. For example, process 900 can be implemented as application-specific circuitry or as a software module including instructions stored at a memory and executed at a processor in communication with the memory. More specifically, for example, process 900 can be implemented at a display client module within a display system.

A data set representing a region of a virtual display (e.g., an updated virtual display at a display control module) is received at block 910. The region is associated with the display client module hosting process 900. In some implementations, the region is uniquely associated with the display client module. That is, the display client module is the only display client module that outputs that region (i.e., the graphical information at that region of the virtual display) to a display device within a display system. In other implementations, the region can be output by more than one display client module within a display system. That is, a region can be associated with a single display client module or with multiple display client modules within a display system.

The data set representing the virtual display region is then decompressed at block 920. For example, a display control module can compress the data set before providing the data set to the display client module via a communications link such as packet-switching communications network.

The decompressed data set representing the virtual display region is the output to a display device at block 930. For example, the decompressed data set can be interpreted and/or decoded and written or drawn to a display buffer at a memory of the display client module implementing process 900. A graphics interface module of the display client module can then access the display buffer and output signals representing the data set to a display device.

Process 900 can include additional or fewer blocks than those illustrated in FIG. 9. For example, in some implementations, a display control module does not compress the data set representing the virtual display region and, thus, block 920 can be excluded. As another example, a display control module can encrypt or encode the data set and process 900 can include additional decryption and/or decoding blocks. In some implementations, a display control module provides a data set representing the virtual display that includes data sets representing multiple virtual display regions. Process 900 can include additional blocks to access a data set representing a particular virtual display region from the data set representing the virtual display. That is, the data set received at block 910 can be a data set representing a virtual display and include multiple data sets each representing a different region of the virtual display. Process 900 can include a block to extract the data set representing a particular region (i.e., a region associated with the display client module implementing process 900) from the data set representing the virtual display. In some implementations, multiple display devices can be operatively coupled to a display client module implementing process 900 and the display client module can perform or execute process 900 for each display device. Additionally, one or more blocks can be rearranged or discarded. Furthermore, although process 900 is discussed above with reference to an example environment within a display system, process 900 is applicable within other environments.

FIG. 10 is a flowchart of a display client process, according to another implementation. Process 1000 can be implemented as a hardware module, as a software module hosted at a computing device, and/or as a combination of a hardware module and a software module. For example, process 1000 can be implemented as application-specific circuitry or as a software module including instructions stored at a memory and executed at a processor in communication with the memory. More specifically, for example, process 1000 can be implemented at a display client module within a display system.

One or more input events are detected at block 1010 and process 1000 returns to block 1010 to detect additional input events if process 1000 is configured (e.g., a display client module implementing process 1000) to wait for additional input events. For example, a display client module can buffer or cache input events for a time interval and/or until a particular number of input events are detected before generating input event descriptors and providing the input event descriptors to a display control module. If process 1000 is no longer configured to wait for additional input events (e.g., a predetermined number of input events have been detected, a time interval for waiting for input events has expired, or process 1000 is not configured to wait for additional input events) at block 1020, input event descriptors are generated at block 1030 for the input events detected at block 1010.

For example, a display client module implementing process 1000 can define an input event descriptor as a data set including location information to identify—relative to the display client module (or a display device or input device operatively coupled to the display client module)—the location or position at which the input event occurred. In some implementations, the location information can identify multiple locations or positions associated with the input event such as a start location and a stop location for a movement input event, a duration for an prolonged contact event, a timestamp of when the input event occurred, and/or multiple locations of contact. Additionally, for example, the data set can include an identifier of a type or class (e.g., contact, multi-touch, movement, or button depression or release) of the input event represented by the input event descriptor and an identifier of the display client module.

The input event descriptors are then provided to a display control module at block 1040. For example, the input event descriptors can be sent to the display control module via a communications network such as an IP communications network. Alternatively, the input event descriptors can be stored at the display client module and provided to the display control module in response to a request from the display control module for the input event descriptors. That is, the input event descriptors can be pushed to the display control module by the display client module or pulled from the display client module by the display control module.

Process 1000 can include additional or fewer blocks than those illustrated in FIG. 10. For example, in some implementations, block 1020 is excluded and an input event descriptor is generated and provided to the display control module each time an input event is detected at block 1010. Moreover, in some implementations, multiple input event descriptors defining a multi-touch input event can be aggregated into an aggregate (or multi-touch) input event descriptor at a display client module and the aggregate input event descriptor can be provided to a display control module rather than providing each of those input event descriptors to the display control module. That is, process 1000 can include a sub-process (e.g., a block or group of blocks) similar to block 752 illustrated in FIG. 7 at which input event descriptors are aggregated. Such aggregate input event descriptors are typically relative to the display client device (or a display device or input device in communication with the display client module). Additionally, one or more blocks can be rearranged or discarded. For example, an input event descriptor can be generated for an input event immediately after that input event is detected. Thus, for example, block 1030 can be moved to be between blocks 1010 and 1020. Furthermore, although process 1000 is discussed above with reference to an example environment within a display system, process 1000 is applicable within other environments.

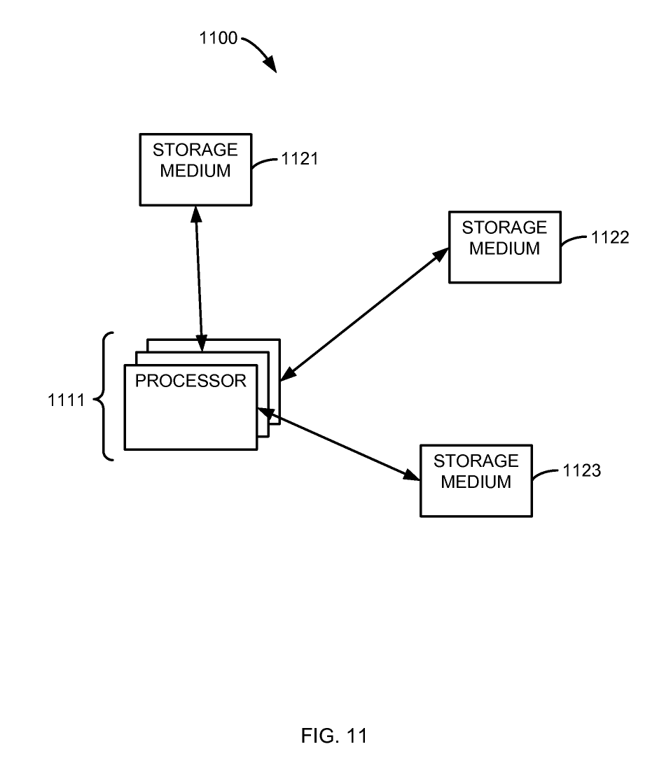

As an example of a system including one or more processors and processor-readable storage media, FIG. 11 is a schematic block diagram of system 1100 including a processor and storage media, according to an implementation. As illustrated in FIG. 11, system 1100 includes one or more processors 1110 operatively coupled to storage medium 1121, storage medium 1122, and storage medium 1123. One or more processors 1110 can access instructions or code at storage medium 1121, storage medium 1122, and storage medium 1123. Storage media 1121, 1122, and 1123 can be any non-transitory processor-readable media and/or related devices to access non-transitory processor-readable media.

For example, storage medium 1121 can be a hard disk drive including a magnetic storage medium, storage medium 1122 can be an optical drive such as a DVD drive and can accept DVD storage media on which processor-readable instructions such as processor-readable instructions that implement a display control module or a display client module can be stored, and storage medium 1123 can be a FLASH memory drive with a USB interface. In some implementations, storage media 1121, 1122, and/or 1123 can be local to (e.g., coupled to a common computing device including) one or more processors 1110. In some implementations, storage media 1121, 1122, and/or 1123 can be remote from (e.g., coupled to a separate computing device) one or more processors 1110 and in communication with one or more processors 1110 via communications link. Furthermore, one or more of storage media 1121, 1122, and/or 1123 can be local to one or more processors 1110 and one or more of the remaining of storage media 1121, 1122, and/or 1123 can be remote from one or more processors 1110.

As a more specific example, one or more processors 1110 can be included within a computing device having an internal hard disk drive data store represented by storage medium 1121 and a removable solid-state data store such as a Secure Digital High-Capacity (“SDHC”) memory card represented by storage medium 1122. The computing device can also include a USB host controller to communicate with a USB FLASH memory drive represented by storage medium 1123. One or more processors 1110 can access processor-readable instructions such as processor-readable instructions that implement a display control module at any of storage media 1121, 1122, and/or 1123. Said differently, one or more processors 1110 can interpret or execute instructions at processor-readable media via storage medium 1121, storage medium 1122, and/or storage medium 1123. For example, a computing device can execute or host a display control module or a display client module stored at a remote storage medium.

Alternatively, for example, storage media 1121 and 1122 can be remote from a computing device including one or more processors 1110 and storage medium 1123 can be local to that computing device. The computing device including one or more processors 1110 can access (e.g., download) a display client module from one or both of remote storage media 1121 or 1122 via communications link such as a communications network to local storage medium 1123 and execute the display client module from local storage medium 1123. As a specific example, the computing device can be a thin client device.

In some implementations, system 1100 can include one or more memories such as RAM that function as a cache between one or more of storage medium 1121, storage medium 1122, and/or storage medium 1123 and one or more processors 1110 for instructions or code stored (or accessible) at one or more of storage medium 1121, storage medium 1122, and/or storage medium 1123.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. Furthermore, it should be understood that the systems and methods described herein can include various combinations and/or sub-combinations of the components and/or features of the different implementations described. Thus, features described with reference to one or more implementations can be combined with other implementations described herein.

What is claimed is:

1. A display system, comprising:
a first display client module;
a second display client module; and
a display control module to provide a first data set associated with a first region of a virtual display to the first display client module and a second data set associated with a second region different from the first region of the virtual display to the second display client module,
the first display client module configured to output the first data set and to provide a first input event descriptor to the display control module at a first time,
the second display client module configured to output the second data set and to provide a second input event descriptor to the display control module at a second time.

2. The display system of claim 1, wherein:
the first input event descriptor is a first touch input event descriptor; and
the second input event descriptor is a second touch input event descriptor.

3. The display system of claim 1, wherein:
the first input event descriptor is a first touch input event descriptor relative to the first region;
the second input event descriptor is a second touch input event descriptor relative to the second region; and
the display control module is operable to:
generate a third input event descriptor relative to the virtual display based on the first touch input event descriptor and a position identifier of the first region,
generate the fourth input event descriptor relative to the virtual display based on the second input event descriptor and a position identifier of the second region,
provide the third input event descriptor to an input processing engine, and
provide the fourth input event descriptor to the input processing engine.

4. The display system of claim 1, wherein:
the first input event descriptor is a first touch input event descriptor relative to the first region;
the second input event descriptor is a second touch input event descriptor relative to the second region; and
the display control module is operable to:
generate a third input event descriptor relative to the virtual display based on the first touch input event descriptor, a position identifier of the first region, the second input event descriptor, and a position identifier of the second region, and
provide the third input event descriptor to the input processing engine.

5. The display system of claim 1, wherein the display control module provides the first data set to the first display client module and the second data set to the second display client module via a communications network.

6. The display system of claim 1, wherein the display control module provides the first data set to the first display client module and the second data set to the second display client module via a packet-switching communications network.

7. The display system of claim 1, wherein:
the first display client includes a touch-sensitive display; and
the second display client includes a touch-sensitive display.

8. The display system of claim 1, wherein the first region does not overlap the second region.

9. A processor-readable medium storing code representing instructions to cause a processor to perform a process, the process comprising:
providing a plurality of data sets associated with a virtual display to a plurality of display client modules, each data set associated with a region from a plurality of regions of the virtual display;
receiving a first plurality of input event descriptors, each input event descriptor from the first plurality of input event descriptors uniquely received from a display client module from the plurality of display client modules; and
providing a second plurality of input event descriptors to an input processing engine, the second plurality of input event descriptors based on the first plurality of input event descriptors.

10. The processor-readable medium of claim 9, wherein each data set from the plurality of data sets is uniquely provided to a display client module from the plurality of display client modules.

11. The processor-readable medium of claim 9, wherein each data set from the plurality of data sets is uniquely provided to a display client module from the plurality of display client modules uniquely associated with the region from the plurality of regions of the virtual display with which that data set is associated.

12. The processor-readable medium of claim 9, wherein each input event descriptor from the second plurality of input event descriptors is uniquely associated with an input event descriptor from the first plurality of input event descriptors.

13. The processor-readable medium of claim 9, wherein:
each input event descriptor from the first plurality of input event descriptors is relative to the display client module from which that input event descriptor was received; and
each input event descriptor from the second plurality of input event descriptors is relative to the virtual display.

14. The processor-readable medium of claim 9, wherein each region from the plurality of regions is uniquely associated with a display client module from the plurality of display client modules, the process further comprising:
generating each input event descriptor from the second plurality of input event descriptors based on an input event descriptor from the first plurality of input event descriptors and a position identifier of the region associated with the display client module from which that input event descriptor from the first plurality of input event descriptors was received.

15. The processor-readable medium of claim 9, wherein each region from the plurality of regions is uniquely associated with a display client module from the plurality of display client modules, the process further comprising:
generating each input event descriptor from the second plurality of input event descriptors based on at least two input event descriptors from the first plurality of input event descriptors and the position identifiers of the regions associated with the display client modules from which the at least two input event descriptors from the first plurality of input event descriptors were received.

16. The processor-readable medium of claim 9, wherein the providing is via a communications network.

17. The processor-readable medium of claim 9, wherein each region from the plurality of regions is exclusive of the remaining regions from the plurality of regions.

18. The processor-readable medium of claim 9, wherein each input event descriptor from the first plurality of input event descriptors is a touch input event descriptor.

19. A user input translation method, comprising:
receiving a first touch input event descriptor from a first display client module;
receiving a second touch input event descriptor from a second display client module;
defining a multi-touch input event descriptor based on the first touch input event descriptor and the second touch input event descriptor; and
providing the multi-touch input event descriptor to an input processing engine.

20. The method of claim 19, wherein:
the first touch input event descriptor is relative to a first region of a virtual display;
the second touch input event descriptor is relative to a second region of a virtual display; and
the multi-touch input event descriptor is relative to the virtual display.
